(19) United States
(12) Patent Application Publication
(10) Pub. No.: US 2007/0136522 A1
(43) Pub. Date: Jun. 14, 2007

(54) Information processing apparatus, media player and method for controlling a storage device

(76) Inventors: Masaya Umemura, Yokosuka (JP); Jun Kitahara, Yokohama (JP); Sunao Sawada, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/635,564

(22) Filed: Dec. 8, 2006

(30) Foreign Application Priority Data
Dec. 8, 2005 (JP) 2005-354289

(51) Int. Cl. G06F 13/00

(52) U.S. Cl. 711/113

(57) ABSTRACT

An information processing apparatus is provided with a performance measuring unit of a storage device, a look-ahead buffer whose capacity can be varied and a power profile which is a power consumption value for each operation mode of the storage device, thereby determining the buffer capacity based on performance measured by the performance measuring unit, the power profile and a playback bit rate and playback time of a video, and, after reading data to the buffer, switching the operation mode to an optimal mode (sleep, standby or idle) in the idle period, which can reduce power consumption.

### CLAIMS OF PRIORITY

The present application claims priority from Japanese application serial No. 2005-354289, filed on Dec. 8, 2005, the content of which is hereby incorporated by reference into this application.

### BACKGROUND OF THE INVENTION

The present invention relates to an information processing apparatus, and more specifically to an information processing apparatus which is suitable for a portable music player or a media player that plays music contents or video contents.

In recent years, portable music players store contents mainly in a flash memory or a hard disk and play them. The players have been shifted from conventional types that play contents from a tape, a CD or an MD. In particular, a music player of the type using a hard disk has an advantage of larger capacity than flash memory and it is popular among users who frequently use a music player. Further, for portable media players which store a large amount of video data and play it, the players today are of the type which incorporates a hard disk.

However, an information processing apparatus incorporating a hard disk is disadvantageous in that power consumption is larger than that of players that store contents in a semiconductor memory such as flash memory, since there are some parts that are operated due to the mechanisms.

In general, an optical disk drive or a hard disk drive is used as a storage device to be incorporated in an information processing apparatus. Such drive rotates a read/write medium, aligns a read or a read/write head with a track on the read/write medium, and reads or reads/writes data. Reading or reading/writing of data becomes possible only after starting up the motor of the drive, stabilizing rotation of record/write medium, and succeeding in position alignment of the head on a track to perform actual reading or reading/writing of data. In addition, even after completing reading and writing of data, the drive will continue rotation. In some cases, the drive will also continue head alignment. This means that considerable energy (product of electric power and time) is required before and after reading or writing the data.

The Japanese Patent Laid-open No. 2003-256087 discloses a technology to reduce CPU power consumption, while focusing on power consumption of the CPU based on power consumption of an optical disk drive. To reduce the CPU power consumption, the CPU references the playback time of the track that is being played on a music recording medium, sets the time to the playback end time that is calculated based on the present time, and transits to the power saving mode.

### SUMMARY OF THE INVENTION

Before and after the time period when the information processing apparatus is reading or writing data, the motor of the disk drive rotates the read/write medium and performs position alignment of the head on a track, thus consuming electric power for driving the motor and aligning the head position.

In particular, conventional drives had a problem that power consumption for reproducing data is wasted since the operation mode is in an active status in which the motor driving and position alignment of the head is maintained to enable reading of voice, music or video files. This is because those files are frequently read out.

If a storage device independently incorporates a mode with low power consumption and a controller provided in the storage device spontaneously switches modes, power-saving effect of mode transition by the controller will be limited. The reason for this is that, since the interval and the capacity of data to be read differ depending on the playback bit rate of the file to be played, it is originally not possible for the controller, which operates passively for a read command from the information processing apparatus, to switch the modes effectively.

Further, if a buffer is provided in an information processing apparatus and data is collectively read out per unit of the capacity of the buffer, and then the mode of the storage device is switched, the interval of data to be read becomes shorter when the playback bit rate becomes higher or the transfer performance of the storage device is low or dynamically becomes lower. Therefore, an apparatus, which incorporates a buffer with its capacity fixed and a mode which transits right after data is read out, has a problem that the overhead that occurs along with mode transition becomes larger than the interval of data reading, which causes a buffer under-run error to interrupt playback. This results in the problem that a file having a high playback bit rate cannot be played.

In addition, with a conventional information processing apparatus using a storage device, even when the playback bit rate becomes higher, the transfer speed of the storage device is deteriorated, or the operation speed of the storage device is low, there has been no measure to obtain the playback bit rate, the transfer performance of the storage device, and information on buffer capacity of the information processing apparatus in order to determine whether or not mode transition can be performed. Therefore, it was not possible for the conventional apparatus to make a determination on whether or not the mode transition is performed based on such information, making it impossible to save the power consumption through the mode transition.

Although the Japanese Patent Laid-open No. 2003-256087 discloses a system to reduce power consumption by switching between the power saving mode and the normal mode using a buffer, it does not disclose a technology to play data stored in a buffer in an optimal mode that reduces power consumption.

An object of the present invention is to provide an information processing apparatus which can determine an optimal transition mode to which mode transition is made after reading out data stored in a look-ahead buffer to play content, prevent playback of the content from being interrupted, and reduce power consumption.

An information processing apparatus according to the present invention includes a performance measuring unit of a storage device; a variable-capacity buffer which stores a read/write scheduler and data that has been read out; and a power profile which is a file that stores information such as a power consumption value for each mode of the storage device.

With the configuration described above, the performance measuring unit measures data transfer performance of the storage device based on the start-up time of the storage device from the time to start the motor to the time to read data and also based on time required to tentatively read and write a predetermined amount of data.

The scheduler reads out the power profile of the storage device.

For a file of voice, music or video, the scheduler reads out the leading portion of the file or the portion in which metadata is stored and extracts the playback bit rate and the playback time from the metadata.

The scheduler determines the capacity of the buffer and capacity of data to be read from the storage device to the buffer at one time based on the performance of the storage device measured by the performance measuring unit, the power profile, the playback bit rate and the playback time. After the data is read, the scheduler immediately switches the mode of the storage device to the optimal mode which will attain less power consumption. Note that, when the performance measuring unit is not provided, performance of the storage device may be written in the power profile.

According to the configuration described above, the performance measuring unit measures the start-up time and the data transfer performance of the storage device, and the scheduler reads the playback bit rate from the power profile of the storage device and the metadata of the playback file. Then, capacity of the buffer and capacity of data to be read from the storage device to the buffer at a time are determined based on the start-up time measured by the performance measuring unit and the data transfer performance, intervals of reading files are adjusted, and the mode is switched to the optimal mode during the interval of reading files, thus enabling reduction in power consumption.

Further, since the scheduler is capable of determining the data transfer performance, playback bit rate, the capacity of the buffer, the capacity of data to be read from the storage device to the buffer at a time and capable of determining whether mode transition is possible, the scheduler restrains the mode transition when a file having a high playback bit rate is played, or when a storage device having low transfer performance is used, or when dynamic transfer performance is deteriorated. Thus, the file can be read and played without any delay, which prevents discontinuity of the playback.

According to the present invention, in an information processing apparatus which includes a storage device, it is possible to determine the optimal transition mode to be switched to after reading out data stored in the look-ahead buffer to play content, prevent playback of the content from being interrupted, and reduce power consumption.

### BRIEF DESCRIPTION OF THE DRAWINGS

FIGS. 1A and 1B are configuration diagrams illustrating an information processing apparatus according to a first preferred embodiment of the present invention.

FIG. 2 is a diagram illustrating a memory map of the information processing apparatus according to the first embodiment of the present invention.

FIG. 3 is a diagram illustrating functions of components and outlined data flow of the information processing apparatus according to the first embodiment of the present invention.

FIG. 4 is a flow chart illustrating processing of the information processing apparatus according to the first embodiment of the present invention.

FIG. 5 is a diagram illustrating power consumption of a hard disk of the information processing apparatus according to the first embodiment of the present invention.

FIG. 6 is a diagram illustrating the relationship between average power consumption and buffer capacity of the hard disk of the information processing apparatus according to the first embodiment of the present invention.

FIG. 7 is a flow chart illustrating procedures for measuring performance of the information processing apparatus according to the first embodiment of the present invention.

FIG. 8 is a diagram illustrating the filling status of the buffer and the operation status of the hard disk of the information processing apparatus according to the first embodiment of the present invention (Part 1).

FIG. 9 is a diagram illustrating the filling status of the buffer and the operation status of the hard disk of the information processing apparatus according to the first embodiment of the present invention (Part 2).

FIG. 10 is a diagram illustrating the filling status of the buffer and the operation status of the hard disk of the information processing apparatus according to the first embodiment of the present invention (Part 3).

FIG. 11 is a diagram illustrating the filling status of the buffer and the operation status of the hard disk of the information processing apparatus according to the first embodiment of the present invention (Part 4).

FIG. 12 is a configuration diagram of an information processing apparatus according to a second preferred embodiment of the present invention.

### DESCRIPTION OF THE PREFERRED EMBODIMENTS

### First Embodiment

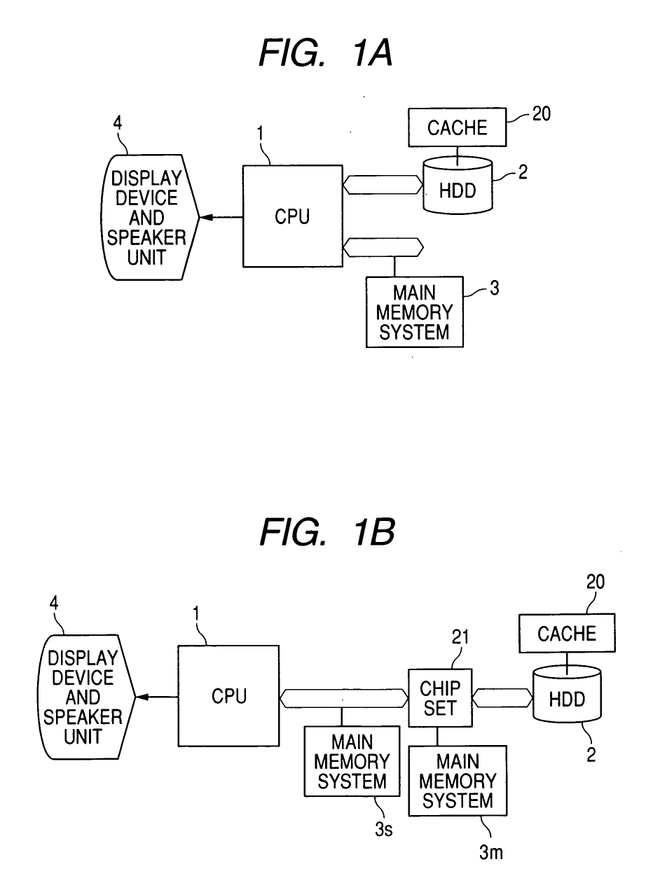

Hereinafter, the first embodiment according to the present invention will be described with reference to FIGS. 1 through 11.

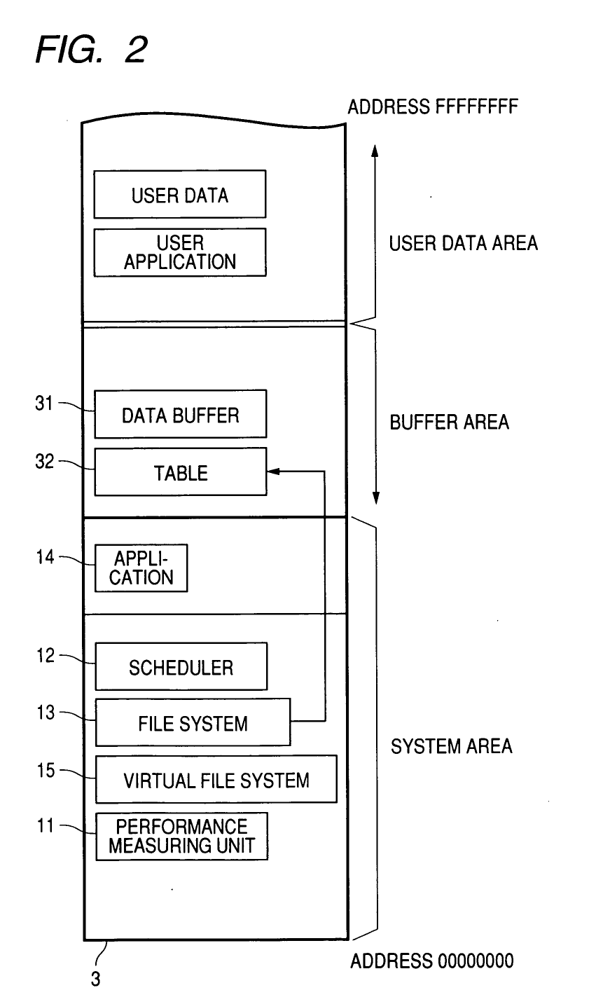

First, a configuration of the information processing apparatus according to the first embodiment of the present invention will be described with reference to FIGS. 1 and 2. FIG. 1 is a configuration diagram illustrating the information processing apparatus according to the first embodiment of the present invention.

FIG. 2 is a diagram illustrating a memory map of the information processing apparatus according to the first embodiment of the present invention.

The information processing apparatus according to the embodiment has a configuration in which a main memory system and an HDD (Hard Disk Drive), or an auxiliary storage device, are connected to the CPU through a bus, as shown in FIG. 1A and FIG. 1B. Difference between FIG. 1A and FIG. 1B lies in the point that FIG. 1B has a chipset.

Information processing apparatuses that is suitable for use with the present invention includes a laptop computer, a portable music player, a portable media player or the like, especially, apparatuses that require a function to obtain low power consumption.

With the information processing apparatus shown in FIG. 1A, a hard disk 2, a main memory system 3, a display device and speaker unit 4 is connected to a CPU 1 via a bus. Further, In the case of using a high-performance CPU, the apparatus, which has the hard disk 2 connected to the CPU 1 via a chipset 21, has a configuration in which a main memory system 3m is connected to the chipset 21, or a configuration in which the CPU 1 and the chipset 21 share a main memory system 3s.

Further, the chipset 21 of the information processing apparatus shown in FIG. 1B is a North Bridge chipset that connects a CPU bus, an I/O bus and a main memory bus. However, chipset 21 may be a companion chip, a bus adapter, or a level-conversion chip available as a simple discrete part.

Furthermore, the display device and speaker unit 4 shown in FIG. 1B is connected to the CPU 1. However, it may be arranged that part of the main memory system 3m is utilized as a video RAM by connecting the display device and speaker unit 4 to the chipset 21 to allow the chipset 21 to transfer display data and voice data to the display device and speaker unit 4.

Control for reducing power consumption of the information processing apparatus according to the embodiment is realized by using software. Functions included in the information processing apparatus are stored in the main memory system 3, 3s and 3m. To map data in the main memory system 3, as shown in FIG. 2, the memory area is divided into a system area, a buffer area and a user data area in this order from the lowest address of the main memory system 3 for allocating each module. In the system area, the OS is installed in the lower-order address side and an application 14 in the upper-order address side. In the diagram, part of functions that configure the OS, a performance measuring unit 11, a scheduler 12, a file system 13 and a virtual file system 15 are illustrated.

In the buffer area, a table 32 which stores configuration information of software and hardware, and a data buffer 31 are allocated. In addition, the OS may allocate a temporary file in the area, which is not illustrated in the diagram.

The table 32 is dynamically updated, and the size of the data buffer 31 is dynamically changed by the OS. The upper-order user data area is an area to be controlled by the virtual file system 15, and applications and files added by a user are stored therein. Files in this area can be copied or moved to and from the hard disk 2 through the intervention of the virtual file system and the file system 13.

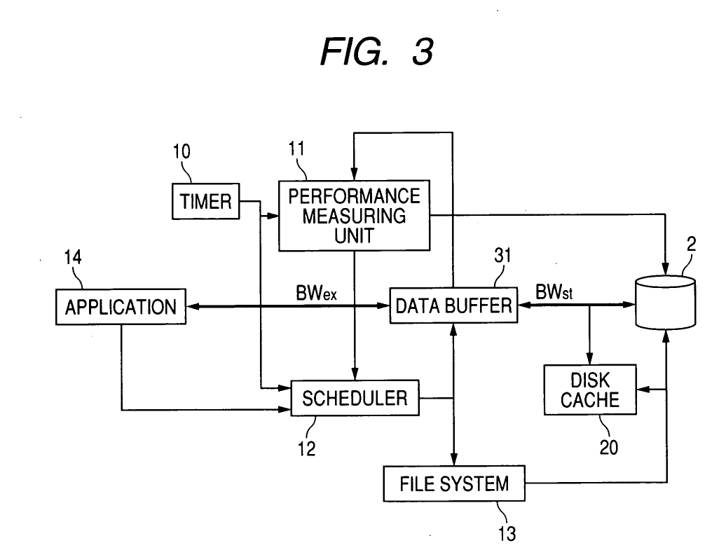

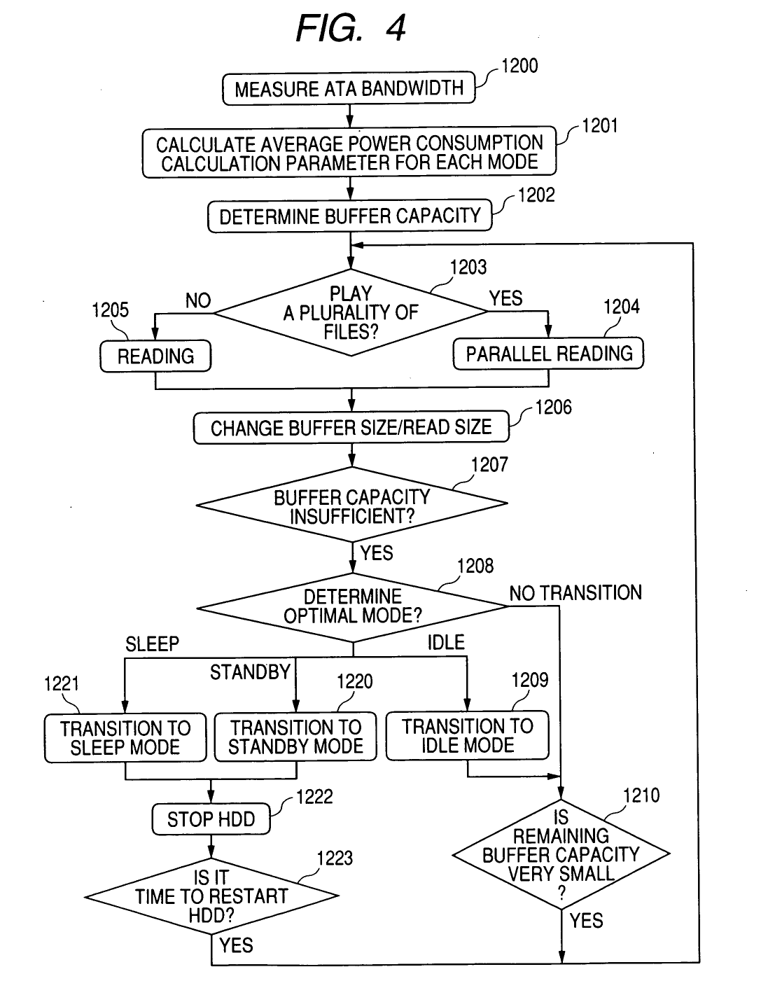

Next, operations of the information processing apparatus according to the first embodiment of the present invention will be described with reference to FIGS. 3 and 4.

FIG. 3 is a diagram illustrating functions of components and outlined data flow of the information processing apparatus according to the first embodiment of the present invention. FIG. 4 is a flow chart illustrating processing of the information processing apparatus according to the first embodiment of the present invention.

First, when the OS is booted, the performance measuring unit 11 shown in FIG. 3 starts up the hard disk 2 and reads out data while referencing a timer 10, measures the time when a data buffer 31 receives the data, calculates the bandwidth, etc., and delivers the calculated results to the scheduler 12 (1200 in FIG. 4). Performance measurement by the performance measuring unit 11 will be described later.

After the OS is booted, when a user started up the application 14 and specifies the file to be played, the scheduler 12 calculates a parameter for calculating the average power consumption for each mode of the hard disk 2 by referencing the playback bit rate shown by the application 14, the power profile of the hard disk and the measurement results of the performance measuring unit 11 (1201). The calculation formula of the average power consumption will be described in detail later. The power profile stores the average power consumption or the maximum power consumption of each operation mode of the storage device. Further, the power profile may include the average power consumption or the maximum power consumption during the period from the time when the storage device starts up to the time when the storage device becomes active, the time required to reach the active status of the storage device, and the transfer performance (bandwidth) of the storage device.

The scheduler 12 shown in FIG. 3 maintains a default value or minimum value of the buffer capacity for each playback bit rate, and obtains the average power consumption for each mode of the hard disk 2 for securable buffer capacity through the calculation formula of the average power consumption for each mode of the hard disk 2 based on the parameter obtained in Step 1201, while taking the default value and the space margin of the buffer area. Then, the scheduler 12 determines a mode to switch the hard disk 2 to the idle period and an appropriate buffer capacity based on the magnitude correlation of the average power consumption values for each mode of the hard disk 2 obtained in the above, and instructs the data buffer 31 to secure the area (1202). Details concerning the mode for switching the hard disk 2 to the idle period and the algorithm for determining the buffer capacity will also be described later.

When the data buffer 12 secures the buffer area, the scheduler 12 instructs the file system 13 to read data, and the file system 13 sends to the hard disk 2 a read command that has the storage position on the hard disk 2 and the read volume (1205).

The data read out from the hard disk 2 is stored in a disk cache 20 on the hard disk 2, and the data is delivered to the application 14 via a buffer 31 on the main memory system 3.

When data is filled in the data buffer 31, the application 14 initiates playback of content and displays or plays the content according to the data on the display device and speaker unit 4. When filling of the data buffer is completed and look-ahead data is filled in the buffer (1207), the processing proceeds to the idle period.

Here, the idle period means the period of time when the hard disk is in a standby status without access to data, and the idle period has the following three types of mode.

Sleep mode: This mode stops the servo of the read head, stops the motor for rotating the disk and stops most of the circuits of the controller chip (HDC) that is mounted on the hard disk 2.

Standby mode: In this mode, although the servo of the read head and the motor for rotating the disk remain stopping, the circuits of the HDC are activated.

Idle mode: In this mode, although the servo of the read head remains stopping, the motor for rotating the disk remains rotating at a low speed.

Among the above-stated modes, the sleep mode consumes the smallest amount of power, the idle mode consumes the largest amount of power, and the standby mode consumes an amount of power between that of the sleep mode and the idle mode.

When the processing proceeds to the idle period, the scheduler 12 determines the optimal mode out of the above-stated three modes based on the power consumption (1208), and switch to the mode that has been determined to be the optimal mode (1221, 1220, 1209, 1210).

Further, when transition is not made to the above-stated mode from the optimal mode, the mode remains in an active mode. The active mode means a status in which access is being made to data or a status in which access is possible.

The optimal mode is determined based on the determination made in Step 1202 shown in FIG. 4. However, when a change/modification is made in the buffer capacity of the data buffer 31 while the information processing apparatus is in operation, the same mode determination as Step 1202 is executed.

When the hard disk 2 is switched to the sleep mode or the standby mode (1221, 1220), the scheduler 12 stops the hard disk 2 (1222). At this time, since the scheduler 12 has already set the timer 10 to the time to restart the hard disk 2 for data transfer, at the restart time (1223), the processing returns to data reading (1203).

In the idle mode, the scheduler 12 monitors the remaining buffer capacity, and when the remaining buffer capacity is very small (1210), the processing returns to data reading (1203).

When a plurality of files are played at a time (1203), data is read in parallel (1204). Since capacity of the buffer and the read size of each file are determined by the scheduler 12 and are modified dynamically (1206), the same mode determination as Step 1202 in FIG. 4 is newly repeated each time a modification is made (1208) as stated in the above to switch to the mode that has been determined to be optimal.

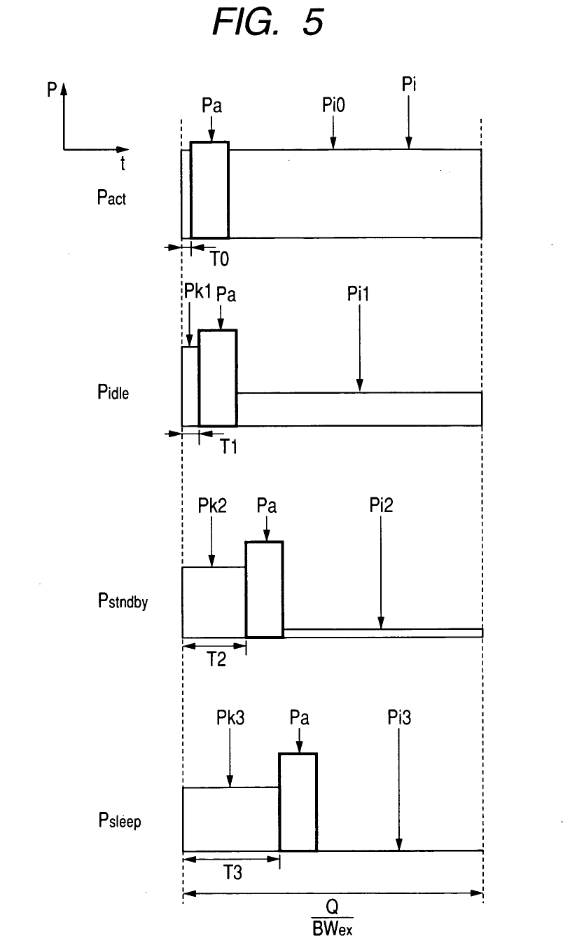

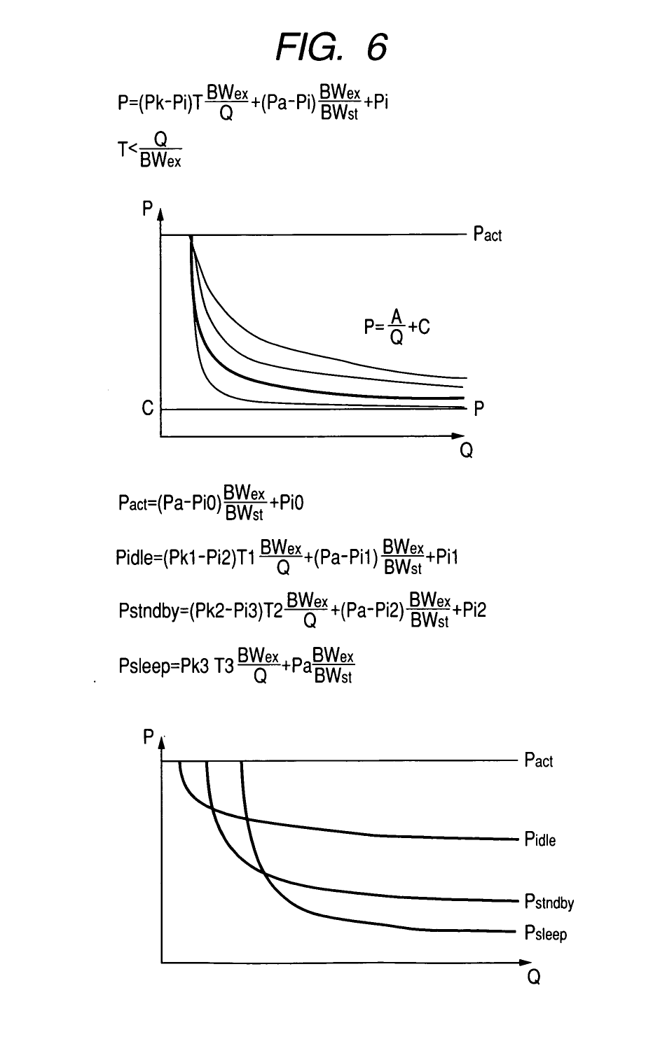

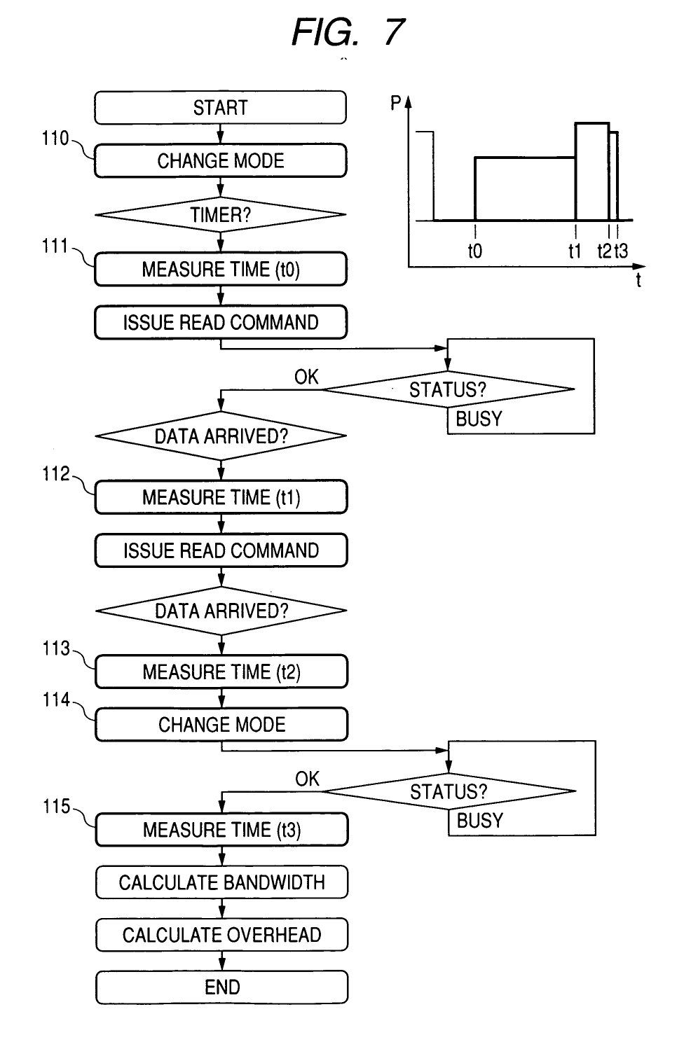

Next, an algorithm of the scheduler 12 for calculating the average power consumption and procedures of the performance measuring unit 11 for executing performance measurement will be described with reference to FIGS. 5 to 7. FIG. 5 is a diagram illustrating power consumption of a hard disk of the information processing apparatus according to the first embodiment of the present invention. FIG. 6 is a diagram illustrating the relationship between the average power consumption and the buffer capacity of the hard disk of the information processing apparatus according to the first embodiment of the present invention. FIG. 7 is a flow chart illustrating procedures for measuring performance of the information processing apparatus according to the first embodiment of the present invention.

In the graphs in FIG. 5, the horizontal axis shows time, and the vertical axis shows the amount of power. The graphs show the power consumption with respect to time. In FIG. 5, time progresses from left to right, and the figure shows power that is consumed in the hard disk 2. When the hard disk 2 is read, the workload equivalent to the average power consumption Pk, the workload equivalent to the average power consumption Pa and the workload equivalent to the average power consumption Pi are consumed in order.

In the power control method of the information processing apparatus according to the first embodiment of the present invention, Pk indicates workload required for preparing to read data, Pa indicates workload required for reading out the data, and Pi indicates workload to be consumed after the reading. The average power consumption that is required for reading out data at a time is calculated by averaging the total of the above workloads for a certain time period.

Here, assuming that the buffer capacity is Q and the playback rate of content is BWex, the time Q/BWex is required for reading at a time, and reading is repeated with a cycle of time Q/BWex.

The work indicated with the average power consumption Pk is the average power consumption that is consumed for position alignment of the motor or the head during the time period before and after data reading of the hard disk 2. Further, the average power consumption Pa is the average power consumption that is used for data reading of the hard disk 2, and the average power consumption Pi is the average power consumption that is consumed during the time period other than the time periods of Pk and Pa, which has been referred to as the idle period.

As a matter of course, the relationship of the above power consumptions is expressed by the following (equation 1).
Pa≧Pk≧Pi (Equation 1)
The modes to which are switched during the idle period of the hard disk 2 includes the active mode, the idle mode, the standby mode and the sleep mode, as described earlier. Hereinafter, the average power consumptions of such modes are expressed as Pact, Pidle, Pstandby, and Psleep, respectively.

The average power consumption Pact of the active mode is the average power consumption in the case where, after data reading expressed as Pa, the application 14 or the file system 13 does not intentionally switch the mode of the hard disk 2. In this active mode, after data reading expressed as Pa, the hard disk 2 is in the standby status with the average power consumption Pi without stopping the servo of the read head and rotation of the motor and waits for arrival of a reading command or a write command. When the next command arrives, the hard disk 2 executes the command after the overhead expressed as the time period T0.

The average power consumption Pidle of the active mode is the average power consumption in the case where, after data reading expressed as Pa, the application 14 or the file system 13 intentionally switches the mode of the hard disk 2 to the idle mode. In this idle mode, the hard disk 2 is in the standby status with the average power consumption Pi1, which is realized by stopping the servo of the read head and reducing the rotation speed of the motor during the idle period. In the status in which mode transition is made to the above mode, when the next command, for example, a read command arrives, the hard disk 2 executes data reading expressed as Pa again after the overhead expressed as the average power consumption Pk1 and the time period T1.

The power consumption Pstandby in the standby mode is the average power consumption in the case where, after data reading expressed as Pa, the application 14 or the file system 13 intentionally switches the mode of the hard disk 2 to the standby mode. In the standby mode, the hard disk 2 is in the standby status with the average power consumption Pi2, which is realized by stopping the servo of the read head and also by stopping the motor during the idle period. In the status in which transition is made to the mode, when the next command, for example, a read command arrives, the hard disk 2 executes data reading expressed as Pa again after the overhead expressed as the average power consumption Pk2 and the time period T2.

The power consumption Psleep in the sleep mode is the average power consumption in the case where, after data reading expressed as Pa, the application 14 or the file system 13 intentionally switches the mode of the hard disk 2 to the sleep mode. In the sleep mode, the hard disk 2 is in the standby status with the average power consumption Pi3, which is realized by stopping the servo of the read head and stopping the motor during the idle period and also by stopping most of the circuits of the controller chip (HDC) mounted on the hard disk 2. In the status in which transition is made to the mode, when the next command, for example, a read command arrives, the hard disk 2 executes data reading expressed as Pa again after the overhead expressed as the average power consumption Pk3 and the time period T3.

Further, the relationship of (Equation 2) stated below exists during the overhead period and the relationship of (Equation 3) stated below exists for the average power consumption for each mode.
T0≦T1≦T2≦T3 (Equation 2)
Pact≧Pidle≧Pstandby≧Psleep (Equation 3)

As described in the above, the power consumption (energy) for the cycle of the hard disk 2 is the total of the areas of the rectangles created by power consumption Pi, Pi1 to 3 which are determined by the mode to which transition is made during the idle period and the rectangles created by power consumption Pk1 to 3 which are required for overhead during the period from the mode transitioned to the time to the active status to be returned, in addition to a rectangle created by power Pa which is actually required for reading and writing data.

In general, when the time of the cycle Q/BWex can be set long, the sleep mode is advantageous since the power consumption Psleep is small (i.e., the power consumption becomes smaller). However, when the time of the cycle Q/BWex is short, the active mode is advantageous in some cases. As stated above, it is noted that an advantageous mode varies according to the time of the cycle Q/BWex.

Hereinafter, the above description will be explained in detail.

In FIG. 6 and in the following description, the symbol T is time required for switching the storage device to the active mode from the idle period; Q, buffer capacity of the storage device; BWex, playback rate of content; BWst, data transfer speed of the storage device; Pa, the average power consumption of the active mode; Pi, the average power consumption of each mode in the idle period; and Pk, the value of the power when transition is made to the active mode from the idle period.

The average power consumption of the Q/BWex for one cycle is expressed by Equation 4 as shown below.
P=(Pk−pi)×T×BWex÷Q+(Pa−Pi)×BWex÷BWst+Pi (Equation 4)

When the hard disk to be used and content to be played are uniquely determined, the above equation can be simplified into the hyperbolic equation of the buffer capacity Q expressed as shown below (Equation 5).
P=A÷Q+C (Equation 5)

Here, the following are assumed:

A=(Pk−Pi)×T×BWex; and C=(Pa−Pi)×BWex÷BWst+pi

As shown in the graphs of FIG. 6, with the equations stated above, the average power consumption P becomes asymptotic to the value C in an area where the buffer capacity Q is large. In an area where the buffer capacity Q is small, the average power consumption P depends on A, and, when A is small, the convex of the hyperbolic curve becomes steeper, thus becoming asymptotic to C. When A is large, the convex of the hyperbolic curve becomes gentle, and it will not easily become asymptotic to C, even in an area where the buffer capacity Q is large.

As already described in FIG. 5, since Pi, Pi1 to 3 and Pk1 to 3 varies depending on the mode to which the hard disk 2 is switched, the equations for calculating the average power consumption differ mode by mode, and thus equations Pact, Pidle, Pstandby and Psleed for calculating the average power consumption can be derived respectively as shown in FIG. 6.

These equations can be expressed with the graphs shown in FIG. 6 when the hard disk to be used and content to be played are uniquely determined.

In the power control method of the information processing apparatus of the present invention, it is assumed that a plurality of contents are stored in the hard disk to be mounted on the apparatus. In this case, if the content to be played is varied, or if a music song, for example, is changed, or the playback bit rate BWex is varied, the equations Pidle, Pstandby and Psleep to be derived for the average power consumption are also changed. More specifically, the equation for calculating the average power to be derived will be different content by content.

Even if the playback bit rate BWex varies, the magnitude correlation among the equations Pidle, Pstandby and Psleep for the average power consumption is retained. As shown in the graphs of FIG. 6, the relationship Pact>Pidle>Pstandby>Psleep is maintained in an area where the buffer capacity Q is large, which means Psleep is smallest. The positions at which Pidle, Pstandby and Psleep start to become lower than Pact depend on the periods T1 to T3 of the overheads Pk1 to Pk3 which was already described for each mode in FIG. 5. Therefore, in an area where the buffer capacity Q is small, an area where Pact is dominant, an area where Pidle is advantageous, an area where Pstandby is advantageous, and an area where Psleep is advantageous will appear in this order.

More specifically, as the buffer capacity Q increases, the average power consumption decreases in the order of Pact, Pidle, Pstandby and Psleep. However, in the case where the buffer capacity Q is limited due to the installation requirements for the information processing apparatus according to the embodiment, such as in the case where the capacity of the main memory system is small, the average power consumption of Pstandby and Pidle, and Pact in some cases, becomes larger. In other words, the mode from which the hard disk 2 is switched to the idle period will not be the sleep mode but will be either one of the standby mode or the idle mode, or in some cases, mode transition will not be executed.

With the control procedures of the information processing apparatus according to the embodiment, a cross-reference table for the playback bit rate and the buffer capacity will be referenced in the step where a playback bit rate of the content to be played is determined, thus obtaining the default buffer capacity Q that corresponds to the playback bit rate.

The buffer capacity Q is then compared with the capacity of the data buffer 31 that has been already secured. When the data buffer 31 has been secured, the average power consumption Pact, Pidle, Pstandby and Psleep are calculated based on the capacity of the data buffer 31, and the mode offering the lowest power consumption will be selected based on their magnitude correlation.

When the data buffer has not been secured, or when there is some space in the buffer area and the data buffer 31 can be increased, the average power consumption for each mode is calculated as stated in the above after securing or increasing the capacity of the data buffer 31, and the mode offering the lowest power consumption will be selected based on their magnitude correlation.

In the status where there is no extra space in the data buffer, the time required for playback Q/BWex that has been pre-fetched to the data buffer becomes shorter than the overhead period until the next look-ahead action is started by the hard disk 2. If the time required for playback is shorter than T3, it is not possible to switch the mode to the sleep mode which offers the smallest average power consumption.

The scheduler 12 of the information processing apparatus of the embodiment prevents the hard disk 2 from being switched to the mode if the above-stated condition T<Q/BWex cannot be satisfied.

Next, an example of procedures for measuring performance of the storage device by the performance measuring unit 12 shown in FIG. 3 will be described with reference to FIG. 7.

Performance measurement can be realized by measuring the time t0 to t3 when a mode of the hard disk 2 is switched, according to the transition of the power consumption illustrated in FIG. 7.

First, concerning the hard disk 2, transition is made to a mode to be measured, such as the sleep mode, the standby mode or the idle mode for example (110). After waiting for a specified period of time, the time to is measured (111). A read command is issued and a response is waited. Upon arrival of data, the time t1 is measured (112). Then, a read command is issued and the time t2 is measured upon completion of data transfer (113). Thereafter, transition is made to a mode to be switched (114), the status of the hard disk 2 is kept to be polled, and the time t3 is measured when transition is made to the mode instructed by the hard disk 2 (115).

Based on the time thus calculated, the performance measuring unit 11 calculates the preparation time for booting or reading (t1−t0), time required for data transfer (t2−t1), and the bandwidth (BWst) and the time required for mode transition (t3−t2) based on the known amount of data that has been read. The total of the preparation time for booting or reading (t1−t0) and the time required for mode transition (t3−t2) thus calculated is the overhead T (either of T1, T2 or T3).

The information processing apparatus according to the embodiment stores at least numeric values of power Pk, Pk 1 to 3, Pa and Pi 1 to 3 as the power profile of the hard disk 2. The values may be the average power consumption or the maximum power consumption as stated in the above.

The performance measured in the procedures shown in FIG. 7 is written and kept, as additional items, to the above-stated power profile in an area which can be referred by the performance measuring unit 11 or the scheduler 12 of the present invention. As stated above, by keeping performance measurement results in a power profile, it is possible to limit performance measurement to a single measurement to be executed at the time of testing the apparatus before shipment or when starting it up for the first time after purchase.

In addition, the power profile may be stored and kept in the hard disk 2.

In particular, it is possible that a hard disk manufacturer can securely write the power profile on a hard disk to allow the performance measuring unit 11 or the scheduler 12 to reference or use the power profile. In this case, the performance measuring unit 11 does not need to measure the performance.

As described in the above with reference to FIGS. 5 to 7, the information processing apparatus according to the embodiment determines advantages/disadvantages of modes to be switched by using the equation for deriving the average power consumption based on the playback bit rate BWex and the buffer capacity Q which are varied depending on the files to be played. When entering the idle period, the information processing apparatus switches the hard disk 2 to an optimal mode, that is, a mode which is anticipated to offer the smallest power consumption. In the description stated above, the average power consumption is used for a power value to be used for each parameter. However, the same calculation may be executed by using the maximum power consumption.

Next, changes in buffer capacity of the data buffer 31 and the operation status of the hard disk 2 in power control of the information processing apparatus according to the embodiment will be described with reference to FIGS. 8 to 11. FIGS. 8 to 11 are diagrams illustrating the filling status of the buffer and the operation status of the hard disk of the information processing apparatus according to the first embodiment of the present invention.

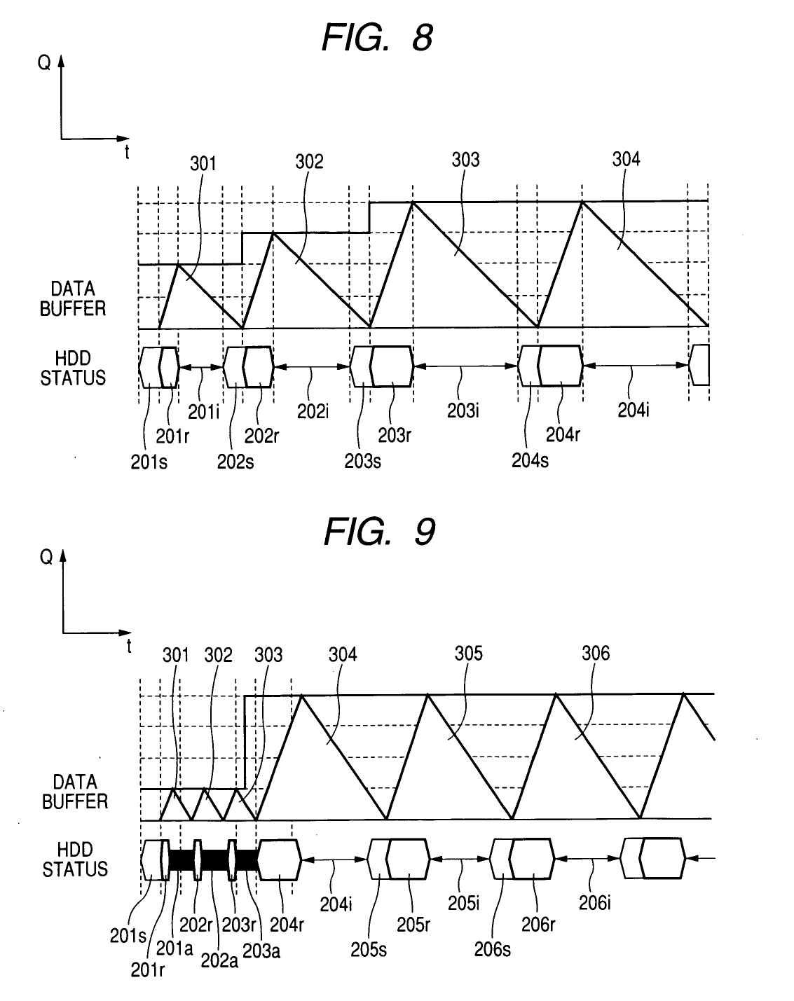

FIG. 8 illustrates an example where the buffer capacity has a sufficient size, and FIG. 9 shows an example where a sufficient size of buffer capacity could not be secured during playback.

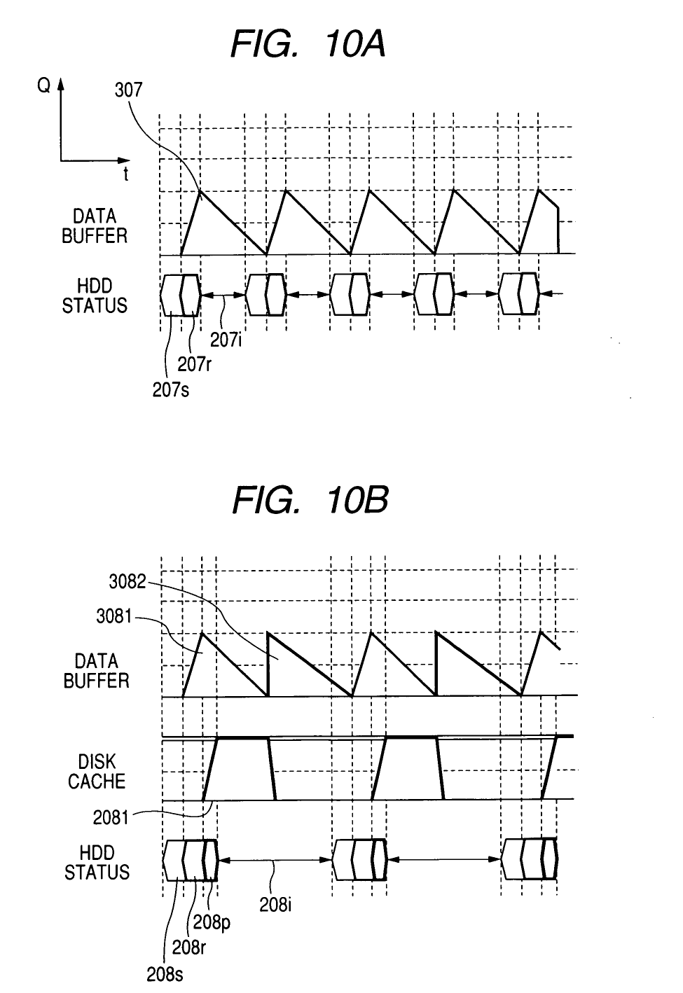

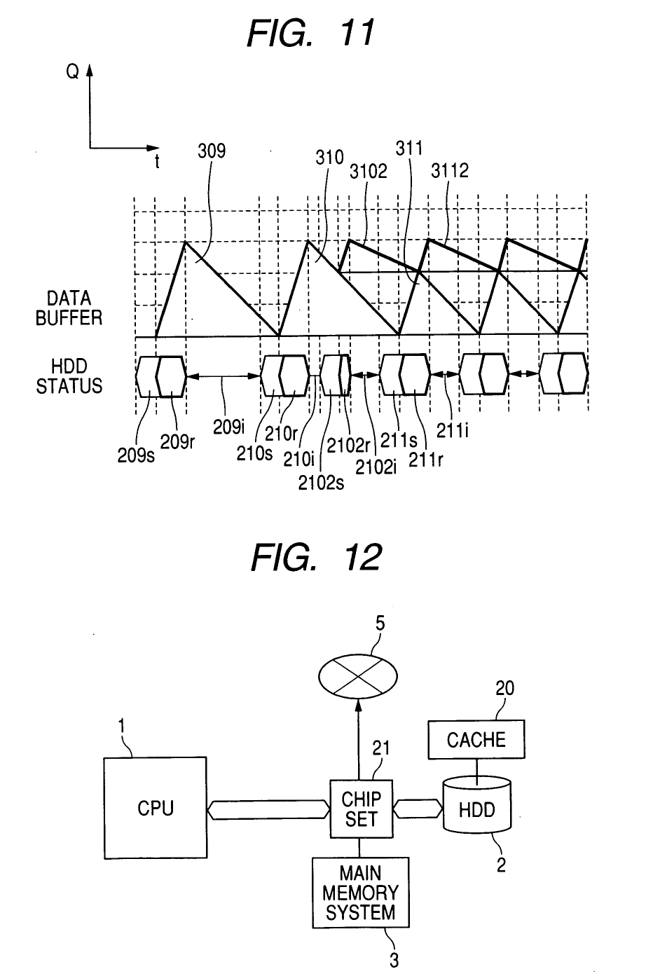

Further, FIG. 10 illustrates operations in the case where the hard disk 2 has a disk cache 20, and FIG. 11 illustrates operations for control to play a plurality of contents by storing them in a buffer.

In FIGS. 8 to 11, time progresses in a horizontal direction from left to right. In the figures, the triangles shown in the upper part show the filling status of the buffer, and the hexagons in the lower part show the operating status of the hard disk 2.

In FIG. 8, the application 14 of the information processing apparatus plays a content file. To read the file, first, the hard disk 2 is started up (201s) and then data reading is executed before the data is transferred to the main memory system 3 from the hard disk 2 (201r). Upon completion of data reading, the file system 13 switches the hard disk 2 to the sleep mode under the algorithm that have been described in the above, according to the scheduler 12 (201i).

The data buffer 31 is filled with data during the data reading period (201r), but the application 14 performs playback when starting data filling. Upon completion of data reading, data stored in the data buffer capacity starts to be reduced to form a triangle shown in the figure (301).

When the remaining space of the data buffer 31 becomes lower than a certain level or the restarting time that is set by the scheduler 12 arrives, the hard disk 2 is booted (202s).

In the example, it is assumed that, at this time, the scheduler 12 can expand the data buffer capacity by 50%. In this assumption, data reading is also resumed with the amount of data to be read that is increased by 50% (202r), and upon completion of data reading, the mode of the hard disk 2 is switched to the sleep mode (202i).

The filling status of the data buffer 31 is expressed by a triangle 302.

When the remaining space of the data buffer 31 becomes smaller than a certain level or the restarting time that is set by the scheduler 12 arrives, the hard disk 2 is booted (203s).

At this moment, the data buffer is expanded again to resume data reading (203r), and, upon completion of data reading, the mode of the hard disk 2 is switched to the sleep mode (203i).

The filling status of the data buffer 31 is expressed by a triangle 303. Thereafter, there is no change in the buffer capacity, and the hard disk is operated in the order of 204s, 204r and 204i. Data filling of the data buffer is repeated and is expressed by a triangle 304.

In the example shown in FIG. 8, since the playback bit rate (BWex) is larger than the data transfer speed (BWst) and the buffer had sufficient capacity Q in any one of the triangle 301 to 304, statuses 201i to 204i appeared. Thus, the power can be saved by establishing the sleep mode during the period of such statuses.

Further, in the case where the capacity of the data buffer 31 is of the triangle 303, the data reading period 203r certainly becomes longer than the period 201r by making the capacity twice as much as the first triangle 301. However, since the ratio of the status 203i relative to the status 201i becomes larger than the ratio of the status 203r relative to the status 201r, the time period when power is not consumed becomes longer. Thus, it is clear that the buffer capacity contributes to the power saving.

On the other hand, in the example shown in FIG. 9, the capacity secured by the data buffer 31 upon initiating playback is half of the capacity shown in FIG. 8. Therefore, the hard disk 2, after being booted (201s), does not have adequate time to execute mode transition during the data reading period from 201r to 202r, and it remains in the active mode (201a). Thereafter, until the data buffer 31 expands the capacity, the statuses 202r, 202a, 203r and 203a are repeated. After the status 204r where the buffer has been enhanced, the step for determining the optimal mode (Step 1028 in FIG. 4) determines that the mode transition is possible, and the status 204i appears. Thereafter, the idle period is switched to the sleep mode.

Also in the example shown in FIG. 9, continuous playback of content and power-saving control are achieved by applying the steps for changing buffer size and determining the optimal mode shown in FIG. 4.

Next, a description will be made of operation rate of the hard disk 2 in the case where the information processing apparatus according to the embodiment utilizes the disk cache 20 on the hard disk and in the case where it does not utilize the disk cache 20, with reference to FIG. 10.

The application 14 shown in FIG. 3 plays a content file. However, the operation of the application 14 varies depending on whether or not the scheduler 12 uses the disk cache 20 on the hard disk 2. FIG. 10A shows the case where the disk cache 20 is not used. FIG. 10B shows the operation status of the hard disk 2 when the disk cache 20 is used.

When the disk cache 20 is not used, the hard disk 2 is started up to read the file concerned (207s). Then, data reading starts to be executed, and data is transferred to the main memory system 3 from the hard disk 2 (207r).

Upon completion of data reading, the file system 13 switches the hard disk 2 to the sleep mode according to the scheduler 12 (207i). The capacity of the data buffer 31 varies as shown by the triangle 307. Thereafter, there is no change in the buffer capacity. The hard disk is operated in the order of 207s, 207r and 207i, and the data buffer repeats the status of the triangle 307.

When the disk cache 20 is used, the hard disk 2 is started up to read the file concerned (208s), data reading starts to be executed, and data is transferred to the main memory system 3 from the hard disk 2 (208r).

Change in the capacity of the data buffer 31 can be expressed by the triangle 3081. Data reading in the hard disk 2 continues even if the data buffer is temporarily fully filled. However, the data buffer 3111 discards all data that arrives subsequently for the reason that the buffer is filled up (208p).

The data that is read during the period (208p) is also stored in the disk cache 20. The amount of the data is equivalent to the capacity of the disk cache 20. The entire data read during the period of the status 208p will be maintained in the disk cache 20 (trapezoid 2081).

Upon completion of reading of a series of the statuses 208r and 208p, the file system 13 switches the hard disk 2 to the sleep mode according to the scheduler 12 (status 208i).

The capacity of the data buffer 31 changes as expressed by the triangle 3081. At the time when the data buffer 31 is depleted, the file system 13 starts reading data on the data cache of the hard disk 2 to fill the data in the data buffer 31 according to the scheduler 12 (triangle 3082).

Thereafter, there is no change in the buffer capacity. The hard disk is operated in the order of 208s, 208r, 208p and 208i. The data buffer repeats the statuses of the triangles 3081 and 3082.

Comparison of operation statuses of the hard disk 2 in the case of using the disk cache 20 with those of the hard disk 2 in the case where the disk cache 20 is not used, the number of starting the hard disk 2 in the case where the disk cache 20 is not used decreases from two to one. When the disk cache 20 is used, the period of the sleep mode is extended.

Next, a description will be made of buffer-filling operations and the operation rate of the hard disk 2 during the playback period of a plurality of files when a plurality of contents are played, with reference to FIG. 11.

First, to play a first file, the hard disk 2 is started up (209s), data is read out to the buffer 31 (209r), and the application 14 starts to perform playback of the first file while the buffer is being filled. Upon completion of data reading, the scheduler 12 stops the hard disk 2. Thus, the power consumption during the idle period will be almost 0 watt (209i).

Since the application 14 continues playback, data stored in the data buffer 31 decreases after completion of data reading, as shown in the filling status expressed by the triangle 309. When the remaining space of the data buffer 31 becomes smaller than a certain level or the restarting time that is set by the scheduler 12 arrives, the hard disk 2 is started up (210s).

When data reading is resumed (210r), a user instructs a second file to be played. The scheduler 12 schedules the reading of the second file after completing reading of the first file. The scheduler 12 first compares the playback bit rates of the first and the second files and determines the buffer capacity for allocating the second file (1206 in FIG. 4).

In FIG. 11, if the playback bit rage of the second file is assumed to be half of the first file, one-third of the capacity that is occupied by the data buffer 31 is allocated to the second file. More specifically, the capacity is allocated to the second file so that the size of the playback bit rate of the file is proportional to the buffer capacity. This is because content having higher playback bit rate offers larger size of data to be played per unit of time. The scheduler 12 restarts the hard disk 2 so that reading of the second file can be started when the remaining space of the data buffer 31 reaches two-thirds of the capacity that is occupied by the data buffer 31 (2102s), and starts reading data when the remaining space of the data buffer 31 becomes less than two-thirds of the capacity (status 2102r).

When reading is started, the application 14 starts playback of the second file. Upon completion of file reading, the scheduler 12 stops the hard disk 2 (status 2101i).

During the period stated above, the application 14 is continuing playback of the first file, and the hard disk 2 is started up when the remaining space of the data buffer 31 becomes lower than a certain level or the restarting time that is set by the scheduler 12 arrives (status 211s).

Upon completing reading of the first file, reading of the second file is started, and the first file and the second file are read consecutively (status 211r). When reading is completed, the scheduler 12 stops the hard disk 2 (status 211i).

Thereafter, according to the remaining space of the data buffer 31 or the restarting time that is set by the scheduler 12, the first file and the second file are read in this order, and the sequential reading will be repeated until playback of either the first or the second file is completed.

As stated in the above, a series of the operations described with reference to FIGS. 8 to 11 are executed according to the procedures shown in FIG. 4. As illustrated in FIG. 8, dynamical change of the buffer size (1205 in FIG. 4) decreases the number of reading data by the hard disk 2, the number of restarting of the hard disk, and the power consumption due to the extended idle period, which results in power-saving effect.

Further, as shown in FIG. 9, even if the buffer capacity is not sufficient, the mode to which the disk is switched during the idle period is determined (1208 in FIG. 4), the mode is retained in the active mode, and the mode is switched to the sleep mode when the buffer capacity of the data buffer 31 increases or when the read size increases (1206 in FIG. 4), which results in reduction in power consumption. As stated above, by changing the buffer capacity to an optimal value with the procedures shown in FIG. 4, it is possible to achieve power saving.

Furthermore, as shown in FIG. 10, by continuing reading even after completing data reading out to the data buffer 31 and storing the data in the disk cache 20 on the hard disk 2, it is possible to reduce the number of reading data by the hard disk 2, thus achieving power saving due to the extended idle period.

In addition, as shown in FIG. 11, when the hard disk 2 starts playback of a file while reproducing another file, the buffer capacity that is secured by the data buffer 31 is dynamically reallocated to the file (1206 in FIG. 4), the scheduler adjusts read timing of a plurality of files that are being played to continuously read the files per file unit. This makes it possible to reduce the number of restarting the hard disk 2, thus achieving power saving due to the extended idle period.

In the present invention, a voice, music or video file to be played is stored in the hard disk 2. However, the hard disk 2 which is included in the information processing apparatus of the present invention may be replaced with an optical disk drive. In this case, it is possible to achieve the similar level of the power saving to a hard disk by stopping the optical disk drive or shutting down the power of the optical disk drive during the idle period in the mode determination step (1208) in FIG. 4. As described in FIG. 5, the mode determination step (1208) in FIG. 4 executes adequate mode control of the optical disk drive during the idle period without stopping the optical disk drive or shutting power thereof if the buffer capacity Q is small or the playback bit-rate BWex is large.

As described in the above, it is possible to save the power by calculating the average power consumption, determining the buffer capacity and pre-fetching data from the hard disk based on the performance measuring unit of the present invention, the power profile of the hard disk and the playback bit rate of the file to be played.

Even if the playback bit rate changes as a result of changing the file to be played, it is possible to reduce power consumption by re-calculating the average power consumption, changing the buffer capacity and determining/deciding the mode to be switched during the idle period.

As described above, it is possible to reduce power consumption by using the power control of the present invention. Further, it is also possible to enhance reliability of the product and extend the service life thereof by switching the mode of the hard disk to idle, stand by or sleep mode during the idle period. This is because, since the read/write head of the hard disk becomes inactive during operation in such modes and moves into an unloading zone (shipping zone) where the head is hardly affected by shocks, it is possible to reduce probability that the head strikes against the recording surface of a disk to give damage on the recording surface or the head itself, or the head sticks to the disk and becomes inoperable.

Further, by switching the mode of the hard disk to the idle, the standby or the sleep mode during the idle period, it is possible to restrict increase of cumulative operation time, extend the product service life that is expressed by MTBF (Mean Time By Fault), and enhance reliability of the product.

Further, since power consumption of the hard disk decreases as a result that the mode of the hard disk is switched to the idle, the standby or the sleep mode during the idle period, heat generation that occurs in association with power consumption of the hard disk can be restricted and the temperature during operation can be reduced, thus improving MTBF. In addition, mechanisms for heat dissipation are not required, which contributes not only to cost reduction, but also to simplification of the product structure, improvement in maintainability, and also to weight saving.

Furthermore, lowering power consumption can extend service life of the battery. If the service life of battery is assumed to be fixed, the number of battery cells can be reduced, thereby enabling weight saving.

### Second Embodiment

Hereinafter, a second embodiment according to the present invention will be described with reference to FIG. 12. FIG. 12 is a configuration diagram of an information processing apparatus according to a second embodiment of the present invention.

The information processing apparatus according to the present embodiment includes, as illustrated in FIG. 12, a CPU 1, a hard disk 2 used as a storage device, a disk cache on the hard disk 2, a main memory system 3 and a chipset 21.

The largest difference between the information processing apparatus according to the first embodiment and that according to the second embodiment is that the information processing apparatus according to the second embodiment is connected to a network 5. The information processing apparatus according to the present embodiment is provided with the storage device which includes the hard disk 2 and is connected to the network 5. A Network Attached Storage (NAS) is assumed for the information processing apparatus according to the second embodiment.

The information processing apparatus according to the embodiment discloses content that is stored in the hard disk 2 to a PC or a video player which includes a media player on a network. When the apparatus receives a request for content transfer from such a player, the apparatus distributes data to the player in a stream format after converting the data from a program stream to a transport stream if the data is in an MPEG format.

The information processing apparatus according to the present embodiment incorporates a mechanism for controlling power of the storage device as described in the first embodiment. When the apparatus receives a request for content transfer from a player, it reads a playback bit rate from the header information/management information of the content. Then, the apparatus calculates the average power consumption for each mode which can be switched by the hard disk 2 during the idle period based on the playback bit rate BWex that has been read, the transfer speed of the hard disk BWst and the buffer capacity of the data buffer that can be secured in the buffer area. The apparatus compares the magnitude correlation of the average power consumptions of the modes and determines the mode that consumes the least power to be the mode during the idle period. Thereafter, the apparatus pre-fetches data to the data buffer. Since the processing proceeds to the idle period when the buffer is filled, the apparatus switches the hard disk 2 to the optimal mode determined according to the algorithm that was described in the first embodiment.

In the embodiment described above, the CPU 1 of the information processing apparatus converts the content data that was pre-fetched to the buffer into a stream format, and transmits the content data to the player via the network 5. However, depending on the interface of the application used in the PC or video player to which the content is distributed, the CPU 1 may be designed so that when the data is in an MPEG format, the content data can be transmitted as partial data of the file in a program stream format, without being converted into a stream format.

The data received is decoded and played on the player side. In this case, since playback may not be performed when the entire data is delivered to the player at a time, it is preferable that the data transfer speed on the network be the same rate as or several times as much as the playback bit rate of the content. Lowering of the transfer speed also offers an advantage that the number of players to which the data is transferred at the same time can be increased.

Since the present embodiment provides a storage device that is connected to a network, it is possible to respond to requests for content distribution from a plurality of players on the network. In this case, when a plurality of contents are requested, as is similar to the information processing apparatus of the first embodiment, the information processing apparatus allocates the buffer capacity and performs pre-fetch operation as shown in FIG. 11. A plurality of contents that are pre-fetched by the data buffer are individually transferred to players that have requested the contents according to the playback bit rate of each content, which enables distribution of content.

As described in the above, according to the present embodiment, it is possible to lower the average power consumption by introducing, to a network storage device, a control technique for obtain a low power consumption.

Further, as a network storage device, for requests for transferring a plurality of contents from a plurality of players, it is possible to lower the average power consumption by pre-fetching the contents in bulk in a data buffer, thus enabling distribution of the contents to respective request sources.

Explanation of reference numerals used in the drawings which is attached to the specification is as follows.

1 . . . CPU, 2 . . . hard disk, 3, 3m, 3s . . . main memory system, 4 . . . display device and speaker unit, 5 . . . network, 10 . . . timer, 11 . . . performance measuring unit, 12 . . . scheduler, 13 . . . . file system, 14 . . . application, 15 . . . virtual file system, 20 . . . disk cache, 21 . . . chipset, 31 . . . data buffer

What is claimed is:

1. An information processing apparatus that playes content that is stored in a storage device, the apparatus comprising:
a buffer that keeps content that is pre-fetched from the storage device;
performance information of the storage device;
a power profile of the storage device; and
a processing device that calculates average a power consumption or a maximum power consumption of each operation mode of the storage device based on the performance information of the storage device, the profile of the storage device and meta data of the content and switches the storage device to an operation mode that is determined based on the calculated average power consumption or the calculated maximum power consumption of each operation mode after pre-fetching the content to the buffer.

2. The information processing apparatus according to claim 1, wherein
the processing device changes the buffer capacity of the storage device based on the performance information of the storage device, the metadata of the content, and the calculated average power consumption or the calculated maximum power consumption of each operation mode of the storage device.

3. The information processing apparatus according to claim 1, wherein
the metadata of the content is a playback rate of the content.

4. The information processing apparatus according to claim 3, wherein
the playback rate of the content is read from header information/management information of the content.

5. The information processing apparatus according to claim 3, wherein
a cross-reference table of the buffer capacity of the buffer is provided for each playback rate of the metadata of the content.

6. The information processing apparatus according to claim 1, wherein
the processing device measures, as performance of the storage device, transfer performance and startup time or time required for shifting to an active mode of the storage device.

7. The information processing apparatus according to claim 1, wherein
the power profile contains average power consumptions or maximum power consumptions of an active, idle, standby and sleep operation modes of the storage device.

8. The information processing apparatus according to claim 7, wherein
the power profile further contains transfer performance, or average power consumption or maximum power consumption at the time of startup or transition to the active mode, or time required for startup or shifting to the active mode, of the storage device.

9. The information processing apparatus according to claim 6, wherein
the power profile is stored in the storage device,
information is written on the power profile by the processing device, or
information is written on the power profile at the time of factory shipment.

10. The information processing apparatus according to claim 1, wherein
the storage capacity of the buffer of the storage device is the total of the storage capacity for buffering that is prepared on a main memory system of the information processing device and the storage capacity for buffering that is prepared on a cache memory.

11. The information processing apparatus according to claim 1, wherein
a plurality of contents are maintained in the buffer.

12. The information processing apparatus according to claim 11, wherein
the buffer capacity to be allocated is determined according to the playback bit rate of each content.

13. The information processing apparatus according to claim 1, wherein
the information processing apparatus is connected to a network, and
the information processing apparatus distributes content that is pre-fetched to the buffer to other devices via the network.

14. The information processing apparatus according to claim 1, wherein
the content is distributed after stream conversion is applied to thereto.

15. The information processing apparatus according to claim 1, wherein
the content is distributed without applying stream conversion thereto.

16. The information processing apparatus according to claim 3, wherein
mode transition is made to a mode that is adapted to reduce the value calculated by the following equation:
“P=(Pk−Pi)×T×BWex/Q+(Pa−Pi)×BWex/BWst+pi”,
where,
T is a time period from the time when the storage device is not in an active mode to the time when the storage is shifted to the active mode;
Q, the buffer capacity of the storage device;
BWex, the playback rate of the content;
BWst, a data transfer speed of the storage device;
Pa, the value of the average power consumption or maximum power consumption of the active mode of the storage device;
Pi, the value of the average power consumption or maximum power consumption of each mode of the storage device other than the active mode; and
Pk, the value of the average power consumption or maximum power consumption of the storage device at the time of shifting to the active mode from the other modes.

17. The information processing apparatus according to claim 3, wherein
the buffer capacity Q is adapted to reduce the value calculated by the following equation:
“p=(Pk−Pi)×T×BWex/Q+(Pa−Pi)×BWex/BWst+pi”,
where,
T is a time period from the time when the storage device is not in an active mode to the time when the storage is shifted to the active mode;
Q, the buffer capacity of the storage device;
BWex, the playback rate of the content;
BWst, a data transfer speed of the storage device;
Pa, the value of the average power consumption or maximum power consumption of the active mode of the storage device;
Pi, the value of the average power consumption or maximum power consumption of each mode of the storage device other than the active mode; and
Pk, the value of the average power consumption or maximum power consumption of the storage device at the time of shifting to the active mode from the other modes.

18. A storage device that stores content to be played by an information processing apparatus, the storage device comprising:
means for keeping performance information on the storage device; and
means for keeping a power profile that contains information on average power consumption or maximum power consumption of each operation mode of the storage device; wherein
the information processing apparatus calculates the average power consumption or maximum power consumption of each operation mode of the storage device based on the performance information of the storage device, the power profile of the storage device, and a playback rate and meta data of content to be played; and switches the storage device to an operation mode that is determined to be optimal, after the content is pre-fetched to the buffer, based on the calculated average power consumption or maximum power consumption of each operation mode.

19. A media player that plays content that is stored in a storage device, the media player comprising:
a buffer that keeps content that is pre-fetched from the storage device;
performance information of the storage device;
a power profile of the storage device; and
a processing device that calculates average power consumption or maximum power consumption of each operation mode of the storage device based on the performance information of the storage device, the power profile of the storage device and the playback rate of content to be played, and switches the storage device to an operation mode that is determined to be optimal, after the content is pre-fetched to the buffer, based on the calculated average power consumption or maximum power consumption of each operation mode.

20. A media player according to claim 19, wherein
the processing device measures the transfer performance of the storage device and the startup time or time required for shifting to an active mode of the storage device, as performance information of the storage device.

21. A method for controlling a storage device of a information processing apparatus that plays content, the method comprising the steps of:
(1) measuring performance information of the storage device;
(2) calculating average power consumption of an operation mode of the storage device;
(3) reading a playback rate of the content;
(4) determining buffer capacity of a buffer for pre-fetching content;
(5) reading content to the buffer for pre-fetching content;
(6) re-setting buffer capacity of a buffer for pre-fetching content or setting the size of data to be read to a buffer for pre-fetching content;
(7) determining an optimal operation mode of the storage device based on a value obtained in the steps (1), (2) and (3) as well as the buffer capacity; and
(8) operating the storage device according to the determined operation mode; wherein
the steps (5) to (8) are repeated following the steps of (1) to (4).
